(19) United States
(12) Patent Application Publication
(10) Pub. No.: US 2006/0164609 A1
(43) Pub. Date: Jul. 27, 2006

(54) Projector having light-shielding module and image processing method thereof

(75) Inventors: Hung-Wen Liu, Gueishan Shiang (TW); Jung-Yao Chen, Taoyuan City (TW); Shih-Hung Yu, Lujhu Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/336,177

(22) Filed: Jan. 20, 2006

(30) Foreign Application Priority Data
Jan. 21, 2005 (TW) 94101918

(51) Int. Cl. G03B 21/14

(52) U.S. Cl. 353/97

(57) ABSTRACT

A projector having a light-shielding module. The projector comprises a housing, a light engine, and a light-shielding module. The housing has a aperture. The light engine includes a projection lens. The projection lens is disposed in the housing, and relative to the aperture in order to project an image. The light-shielding module has an adjustable light-shielding zone, and is used for selectably shielding the image.

This application claims the benefit of Taiwan Application Serial No. 094101918, filed Jan. 21, 2005, the subject matter of which is incorporated herein by reference.

### BACKGROUND OF THE INVENTION

1. Field of the Invention

The invention relates to a projector, and more particularly to a projector having an electronic light-shielding module.

2. Description of the Related Art

The conventional projector produces a micro-image through the optics and microdisplay of the light engine, whereupon the micro-image is amplified and projected onto a screen by the projection lens. Herewith a projected image is produced.

Generally, the conventional projector has a mechanical parts lens cap. Users have to attach the lens cap to the projection lens manually for shielding the light source emitted from the projector, once they want to finish projecting image. It is to say that the lens cap works as a shielding member for ending projecting. Because the position of a speaker are usually beside the screen, which is the furthest distance from the projector. On some occasions such as meeting or briefing against the clock especially, it is time consuming for shielding light source such as putting the lens cap on by the speaker personally or by other people directed by the speaker. In particular, in the conference hall where the projector is fitted to the ceiling, users even have to spend more time to be near to the projector in order to put the lens cap over.

### SUMMARY OF THE INVENTION

It is therefore an object of the invention to provide a projector with electronic light-shielding device. The transmissive panel is disposed in front of the projection lens. The modulation panel could be adjusted by means of electronic control for the light-shielding effect, completely or partially. Users are able to project or close the projected image by remote control.

It is therefore an object of the invention to provide a processing method of projecting image. Herein the transmissive panel is disposed in front of the projection lens and the modulation panel is adjusted by electronic control, so as to have the effect of varied light-shielding and transmitting outcomes.

It is an object of the present invention to provide a projector. The projector includes the housing, the light engine, and the light-shielding module. The housing has an aperture and the light engine includes the projection lens. The projection lens is disposed in the housing and relative to the aperture. The projection lens is to project a projected image. The light-shielding module has an adjustable light-shielding zone, for selectabley shielding projected image.

It is an object of the present invention to further provide a light-shielding module, for being disposed in the optical instrument. The optical instrument at least has a projection lens. The light-shielding module includes: the modulation panel and the control unit. The modulation panel is disposed in front of the projection lens and has a plurality of matrix permutation of pixels. The modulation panel could adjustably form a light-shielding zone. The control unit is to receive a signal and accordingly set the pixels.

It is an object of the present invention to further provide a processing method of projected image. The processing method includes the following steps: providing a modulation panel having a plurality of pixels positioned in front of a projection lens; selecting a light-shielding zone of the modulation panel; setting the light-shielding zone and setting a plurality of pixels of the light-shielding zone as light-shielded.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is the partial three-dimensional diagram of the projector according to a preferred embodiment of the present invention.

FIG. 2 is a lateral view of the projector depicted in the FIG. 1.

FIG. 3 shows a block diagram of the projector according to the FIG. 1.

FIG. 4 is a flow chart illustrating the image processing method of the light-shielding module depicted in FIG. 3.

FIG. 5A is a front view of the projection panel as the image is projected by the projector invention, and FIG. 5B is a front view of the projection panel as no image is projected by the projector according to a preferred embodiment of the present.

### DETAILED DESCRIPTION OF THE INVENTION

An electronic light-shielding module is provided according to the present invention. A transmissive panel is disposed in front of the projection lens. A modulation panel could be adjusted into completely or partly light-shielding outcome by electrical control. Users could project or close the projected image through selectably shielding the light emitted from the projection lens by remote control. This invention is described by taking a projector as an example. However the scope of the invention is not limited thereto.

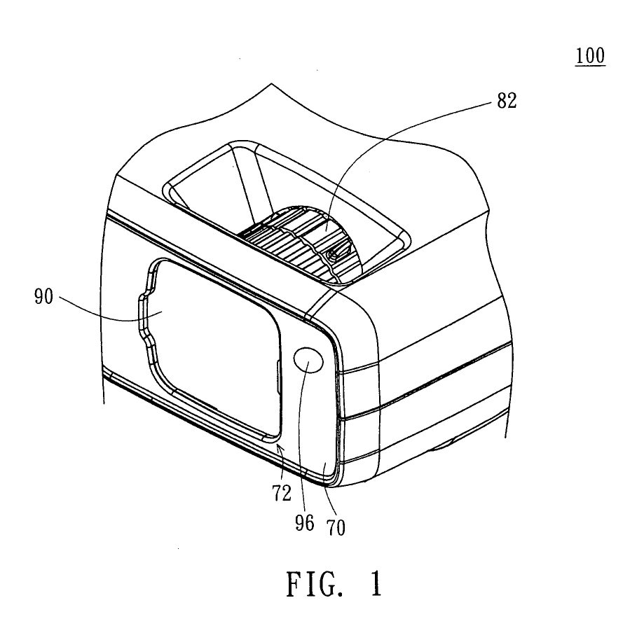

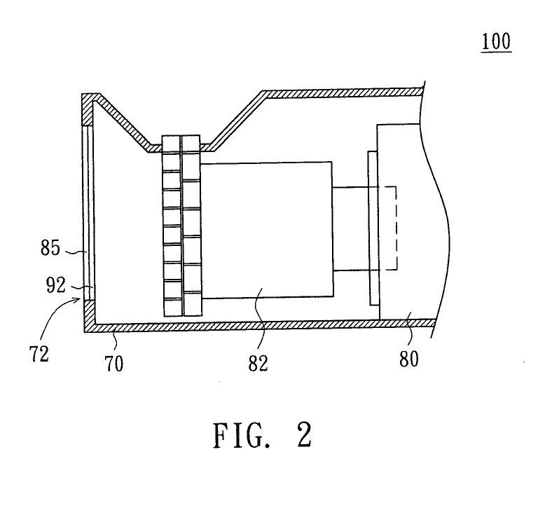

Referring to FIG. 1 and FIG. 2, FIG. 1 is a partial three-dimensional diagram of the projector according to a preferred embodiment of the present invention. FIG. 2 is a lateral view of the projector depicted in FIG. 1. The projector 100 includes a housing 70, a light engine, and a light-shielding module 90 and a hard coat (labeled 85 in FIG. 2). The housing 70 has an aperture 72. The light engine (labeled 80 in FIG. 2) includes a projection lens 82, which is disposed in the housing 70 and relative to the aperture 72. The light-shielding module has an adjustable light-shielding zone, for selectably shielding the light projected from the projection lens 82.

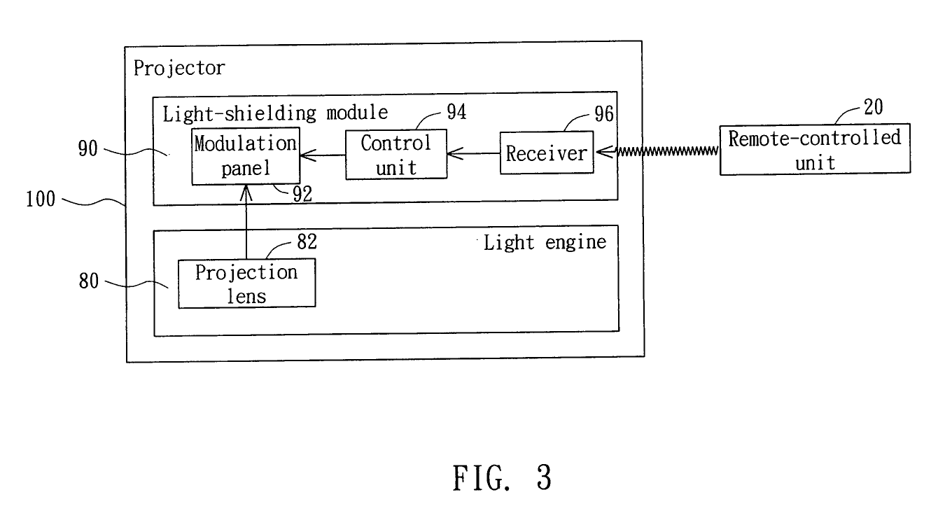

FIG. 3 illustrates the block diagram of the projector depicted in FIG. 1. The light-shielding module 90 includes a modulation panel 92, a receiver 96 and a control unit 94.

As shown in FIG. 2, the modulation panel 92 is provided with a plurality of pixels arranged in matrix. The modulation panel 92 is disposed in front of the projection lens 82 and relative to the aperture 72. The preferred modulation panel 92 is a transmissive panel such as a Liquid Crystal Display Panel or a transmissive Liquid Crystal on Silicon (LCOS).

As shown in FIG. 3, the receiver is used for receiving signals and outputting into the control unit 94 accordingly. The receiver such as an IR receiver 96 is used for receiving a remote signal. The control unit 94 is used for receiving a signal and accordingly setting a plurality of pixels in the light-shielding zone of the modulation panel 92 as light-shielded, so as to form the light-shielding zone.

In the present invention, the processing method of projected image includes the following steps: providing a modulation panel in front of a projection lens, and herein the modulation panel has a plurality of pixels arranged in matrix, selecting a light-shielding zone of the panel, and setting the light-shielding zone, namely setting a plurality of pixels in the light-shielding zone as light-shielded.

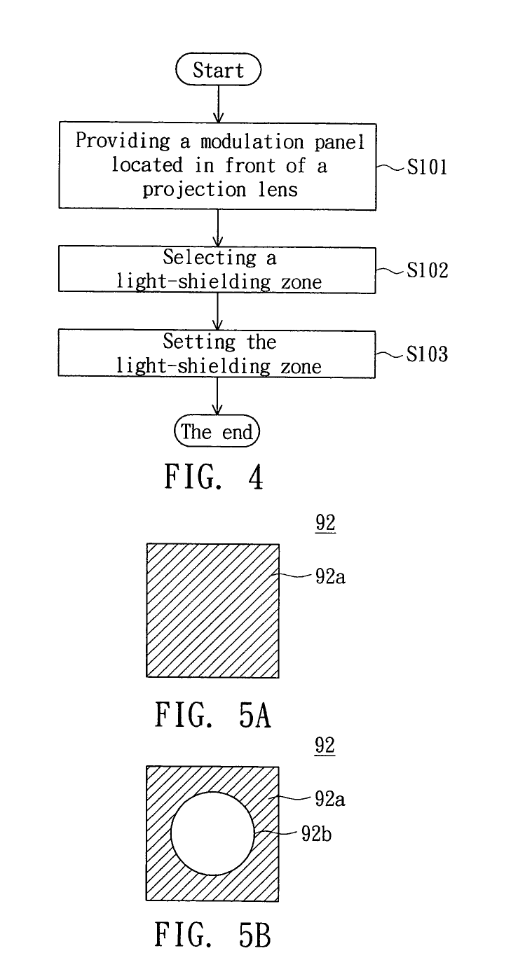

Referring to FIG. 3 to FIG. 4, FIG. 4 shows a flow chart of the image processing method of the light-shielding module depicted in FIG. 3. The projector 100 of the present invention produces a micro-image through the light engine 80, and accordingly, a projected image is produced by the projection lens 82. In the step S101 of providing modulation panel, the modulation panel 92 has a plurality of pixels arranged in matrix and is disposed in front of the projection lens 82. In the step S102 of selecting light-shielding zone, users select light-shielding zone 92a through manual editing or auto-editing. The selecting instruction is outputted into the receiver 96 via a remote-controlled unit 20. The instruction includes the corresponding pixels in the direction of horizontal and vertical to the border of the light-transmitting zone. In the step S103 of setting light-shielding zone, after the control unit 94 receiving the signal, the pixels in the light-shielding zone of the modulation panel 92 is set to be opaque accordingly. The rest of the modulation panel 92 is set to be a light-transmitting zone, and a plurality of pixels of the light-transmitting zone is set to be transmitting, so that the projected image could be processed accordingly.

This following diagrams of the light-shielding zone are taken as example and the processing effects of the projected image produced thereof are illustrated. This invention is described by taking several embodiments as examples according to the spirit of the invention. However the scope of the invention is not limited to the examples.

Referring to FIG. 5A is the front view of the modulation panel of the present invention illustrating the projector when images are projected. When projector projects images, part of the modulation panel forms light-shielding zone 92a. And when another part of the modulation panel 92 forms a light-transmitting zone 92b relative to the projection lens, a light projected from the projection lens passes through the light-transmitting zone 92b and an image is projected onto a screen. Through the fine-adjustable light-transmitting zone, the electronic light-shielding module could be used for shielding the light stray except the projected images, and modifying the light leakage except the projected image. Accordingly, the display quality of the projected images is improved substantially.

Referring to FIG. 5 is the front view of the modulation panel illustrating that the projector is not projecting images according to the preferred embodiment. When the projector is not projecting images, the light-shielding zone is relative to the projection lens. For example, the light-transmitting zone coincides with the projection lens substantially. The light-shielding zone 92a completely shields the light projected from the projection lens. At this time, the modulation panel 92 completely shields the light projected from the projection lens so as to function as a lens cap. In comparison with the conventional mechanical lens cap, users are able to change the light-shielding module from projecting state into light-shielding state simply by remote control for switching projected image immediately especially for the projector which is mounted on the ceiling. The light-shielding module employs the remote control so as to solve the problem of the inconvenience caused by the attached lens cap and the removed lens cap. Furthermore, users are able to select the medium for briefing such as white board, projected image or posters in some occasions like briefing or meeting against time to reduce meeting time and create enterprise competitiveness.

Referring to FIG. 2, the projector 100 of the preferred embodiment further includes a hard coat 85, which is disposed in the aperture 72. For example, the hard coat connects to the wall of the aperture so as to be embedded into the aperture. As a consequence, the modulation panel could be protected and dust-proof effect is also achieved. In addition, the modulation panel 92 is preferably disposed in the back of the hard coat 85 and tightly fitted into the hard coat 85. The hard coat is used for protecting the modulation panel 92 and the projection lens 82. As for the outward appearance of the projector, the hard coat 85 and the modulation panel 92 are mounted onto the housing according to the preferred embodiment so as to maintain the consistency of the entire modeling of the projector 100.

The above-mentioned embodiment discloses the projector having light-shielding module and the processing method of the projected image. Herein the transmissive panel is disposed in front of the projection lens and the modulation panel is switched into varied light-shielding or transmitting effect via electrical control. Firstly, the modulation panel could be changed into completely light-shielding effect via electrical control. Users could project or close the projected image by remote control, it will not only save trouble switching the lens cap, but reduce meeting time by the cross application of various briefing media. Therefore, the operating efficiency is improved and the competitiveness in business operation and management is enhanced. Furthermore, the modulation panel is adjustable to produce partial light-shielding effect and partial transmitting. In the case of manual operating is not required but only remote control is needed, the modulation panel is partial light transmitting, so that the projected image could passes through. Furthermore, the modulation panel could shield the light stray beyond the projected image by micro-adjusting the border of the light-transmitting zone so as to have better projection quality. On the other hand, in the appearance of the projector, the hard coat and the modulation panel are mounted onto the housing. As a result, protective and dust-proof effect is enhanced and also the consistency in whole modeling of the projector could be maintained.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projector, comprising:
a housing having an aperture;
a light engine, comprising:
a projection lens disposed in the housing and relative to the aperture for projecting an image;
a light-shielding module having an adjustable light-shielding zone for selectably shielding the image.

2. The projector according to claim 1, wherein the light-shielding module comprises:
a modulation panel, having a plurality of pixels arranged in matrix, disposed in front of the projection lens and relative to the aperture; and
a control unit for receiving a signal and accordingly setting the pixels in the light-shielding zone as light-shielded, whereby the light-shielding zone is formed in the modulation panel.

3. The projector according to claim 2, wherein when the light-shielding zone is relative to the projection lens, the light-shielding zone completely shields the projection lens and functions as a lens cap,

4. The projector according to claim 2, wherein when a part of modulation panel forms the light-shielding zone, and the other part of modulation panel forms a light-transmitted zone relative to the projection lens, a light beam emitted from the projection lens passes through the light-transmitted zone and forms an image onto a screen.

5. The projector according to claim 2, wherein the light-shielding module further comprises a receiver, for receiving the signal and accordingly outputting the signal to the control unit.

6. The projector according to claim 5, wherein the receiver is an IR receiver and the signal is a remote signal.

7. The projector according to claim 2 further comprising a hard coat covering the aperture, the modulation panel disposed in the back of the hard coat and tightly fitted onto the hard coat.

8. The projector according to claim 2, wherein the modulation panel is a transmissive panel.

9. The projector according to claim 2, wherein the modulation panel is a Liquid Crystal Display Panel.

10. The projector according to claim 2, wherein the modulation panel is a Liquid Crystal on Silicon (LCOS).

11. A light-shielding module for being disposed on an optical instrument which at least is provided with a projection lens for projecting an image, the light-shielding module comprising:
a modulation panel disposed in front of the projection lens, wherein the modulation panel has a plurality of pixels arranged in matrix for adjustably forming a light-shielding zone; and
a control unit for receiving a signal and accordingly setting the pixels in the light-shielding module as light-shielded so as to form the light-shielding zone, whereby the projected image is adjustably shielded by the light-shielding module.

12. The light-shielding module according to claim 11 further comprising a receiver for receiving the signal and accordingly outputting the signal to the control unit.

13. The light-shielding module according to claim 12, wherein the receiver is an IR receiver, and the signal is a remote signal.

14. The light-shielding module according to claim 11 further comprising a hard coat covering the aperture, the modulation panel being disposed in the back of the hard coat and tightly fitted thereupon.

15. The light-shielding module according to claim 11, wherein when the light-shielding zone is relative to the projection lens, the light-shielding module shields the projection lens completely and functions as a lens cap.

16. The light-shielding module according to claim 11, wherein when a part of the modulation panel forms the light-shielding zone, and the other part of the modulation panel forms a light-transmitted zone relative to the projection lens, a light beam emitted from the projection lens passes through the light-transmitted zone and forms a projected image onto a screen.

17. The light-shielding module according to claim 11, wherein the modulation panel is a transmissive panel.

18. A projected image processing method, comprising steps of:
providing a modulation panel located in front of a projection lens, the modulation panel having a plurality of pixels;
selecting a light-shielding zone in the modulation panel; and
setting the light-shielding zone; and
setting the pixels therein as light-shielded.

19. The image processing method according to claim 18, wherein the light-shielding zone is substantially coincidence with the projection lens, so that the modulation panel shields the projection lens and functions as a lens cap.

20. The image processing method according to claim 18, wherein step of setting the pixels in the light-shielding zone as light-shielded further comprises:
setting the rest of the modulation panel as a light-transmitted zone, and setting a plurality of pixels of the light-transmitting zone as transmitting; and
the projection lens projecting a projected image and the image passing through the light-transmitting zone and displaying on a screen.
